(19) United States
(12) Patent Application Publication
(10) Pub. No.: US 2012/0297740 A1
(43) Pub. Date: Nov. 29, 2012

(54) OIL MIST SEPARATOR

(76) Inventor: Mao-Nan CHENG, Taichung City (TW)

(21) Appl. No.: 13/115,259

(22) Filed: May 25, 2011

(51) Int. Cl. B01D 50/00; B01D 45/16

(52) U.S. Cl. 55/326

(57) ABSTRACT

An oil mist separator includes a first filtrating unit, a second filter unit and a third filter unit. The first filter unit contains plural first filters and the second filter unit contains plural second filters, for sucking oil mist air to flow spirally so as to remove oil and water mixed in the mist, utilizing a centrifugal force. The third filter unit can directly remove oil and water possibly still existing in the air. So the oil mist separator can not only make air contaminated by oil totally recovered by three stages of separation, but also reduce consumption of filter to lower cost and be friendly to environment.

### BACKGROUND OF THE INVENTION

1. Field of the Invention

This invention relates to an oil mist separator.

2. Description of the Prior Art

Cooling fluids or cutting fluids are commonly used in factories, creating a lot of oil mist. And cooking oils are massively used in kitchens of the restaurant industry, also producing a great amount of oil mist. In order to prevent oil mist from contaminating indoor air so as not to affect health and working mood of workers, conventional oil mist separators have been used in factories and kitchens to remove oil mist. Such simple conventional oil mist separators are mainly provided with a shell having a filtration chamber installed with a filter, an air inlet and an air exit communicating with the filtration chamber. A blower is installed in the air exit, employed to suck air to flow into the filtration chamber, pass through the filter to get filtered and run out of the air exit. However, the conventional oil mist separators have been found disadvantages of not only having to costly consume the filter, but also impossibility to effectively remove oils from the air.

To overcome the disadvantages of the conventional oil mist separators, the inventor of the present invention has already devised two improved conventional oil mist separators, disclosed in Taiwan Patent No.M333521 “Multi-tube centrifugal oil mist separator” and No.M360074 “Oil mist separator”. These two oil mist separators are mainly provided with plural centrifugal filtering devices installed in a filtration chamber for air contaminated by oil to flow spirally, so that oil and water contained in the air can be separated out by a centrifugal force without using a filter. And they are actually appreciated well.

But, after a long term of observation, it is found that a little lighter oil and water can not yet be separated out, even thought most of the oil and water have been removed away.

### SUMMARY OF THE INVENTION

The object of this invention is to offer an oil mist separator, utilizing a centrifugal force to lessen consumption of filters.

The main characteristics of the invention are a shell, a first filter unit, a second filter unit, an inlet unit and a third filter unit. The oil separator includes a shell composed of plural layers separated by a first separating plate, a second separating plate and a third separating plate positioned upward in order consecutively, so that a first chamber, a second chamber, a third chamber and a fourth chamber are correspondingly defined. The first separating plate is provided with plural first through holes. The second separating plate is provided with plural second through holes. The third separating plate is provided with at least a third through hole. Moreover, the shell is also provided with an air inlet bored in one side to communicate with the first chamber, an air exit bored in the top to communicate with the fourth chamber. The first filter unit is installed in the first chamber, provided with a first fixing plate parallel to the first separating plate. The first fixing plate is bored with plural first fixing holes corresponding to the first through holes. Installed between the first separating plate and the first fixing plate are plural first filters. Each of the first filters is provided with an inner tube having an upper end connected with the first through hole and a lower end kept free. An outer tube surrounds part of the inner tube, with an upper end flatly sealed with the inner tube and a lower end gradually tapered downward to form a conical portion connected with the first fixing hole. In addition, an opening is formed at one side of the outer tube, located between the first separating plate and the first fixing plate. The second filter unit is installed in the second chamber, provided with a fixing tank having a circumferential wall connected with the second separating plate and a bottom wall formed at the bottom. The exterior surfaces of the circumferential wall and the bottom wall are spaced apart the inner wall of the shell with a preset distance, so that a passage is formed between them. A plurality of through holes are bored around the circumferential wall. Deposited in the fixing tank is a second fixing plate parallel to the second separating plate. The second fixing plate is bored with plural second fixing holes corresponding to the second through holes of the second separating plate. Plural second filters are installed between the second separating plate and the second fixing plate, with each of the second filters provided with an inner tube having an upper end connected with the second through hole and a lower end kept free. An outer tube surrounds part of the inner tube, with an upper end flatly sealed with the inner tube and a lower end gradually tapered downward to form a conical portion connected with the second fixing hole. In addition, an opening is formed at one side of the outer tube, located between the second separating plate and the second fixing plate. An inlet unit is installed in the third chamber, provided with a fixing plate parallel to the third separating plate, with plural through holes bored around the fixing plate. The inlet unit also includes a blower provided with a motor installed between the third separating plate and the fixing plate. The motor is provided with an output shaft inserted through the fixing plate to connect with a blade. The third filter unit is installed in the fourth chamber, provided with at least a layer of filter.

The oil mist separator can be installed in kitchens or factories full of oil mist, for sucking oil mist into the shell. With the first filter unit enabling the oil mist to flow spirally, most of the oil and water mixed in the air can be removed owing to a centrifugal force. Again, with the second filter unit enabling the oil mist passing through the first filter unit to flow spirally, the oil and water still remaining in the air can be further removed. Finally, with the third filter unit, the slight oil, water, odor and powders possibly still existing in the oil mist passing through the second filter unit can be effectively and almost completely removed. Thus the oil mist separator can not only make the air contaminated by oil totally recovered with a multi-layer filtration, but also reduce consumption of filters to lower cost and be friendly to environment.

### BRIEF DESCRIPTION OF DRAWINGS

This invention is better understood by referring to the accompanying drawings, wherein:

FIG. 1 is a perspective view of a preferred embodiment of an oil mist separator in the present invention;

FIG. 2 is a cross-sectional view of the preferred embodiment of an oil mist separator in the present invention;

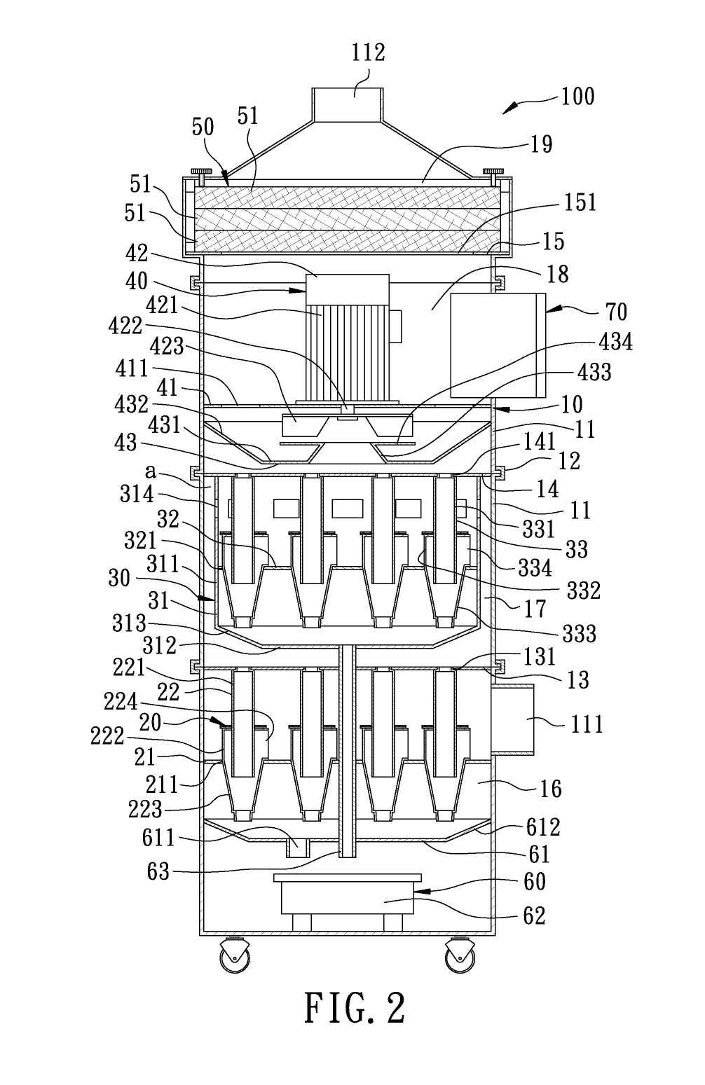

FIG. 3 is an exploded perspective view of an upper half portion of the preferred embodiment of an oil mist separator in the present invention;

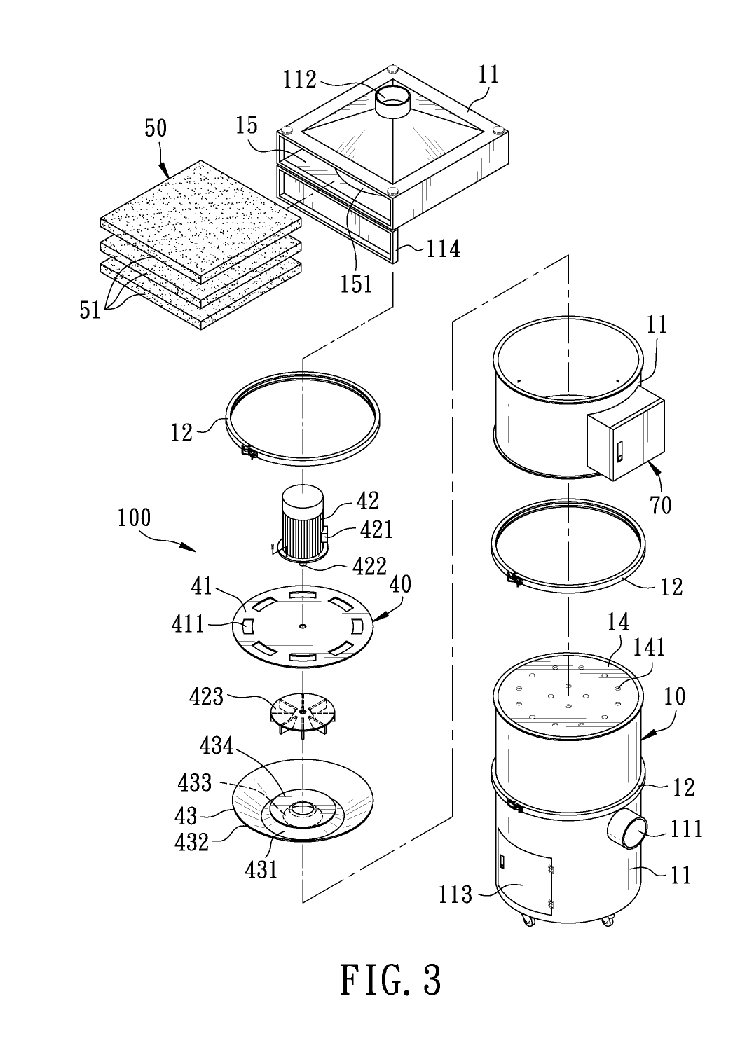

FIG. 4 is an exploded perspective view of a lower half portion of the preferred embodiment of an oil mist separator in the present invention;

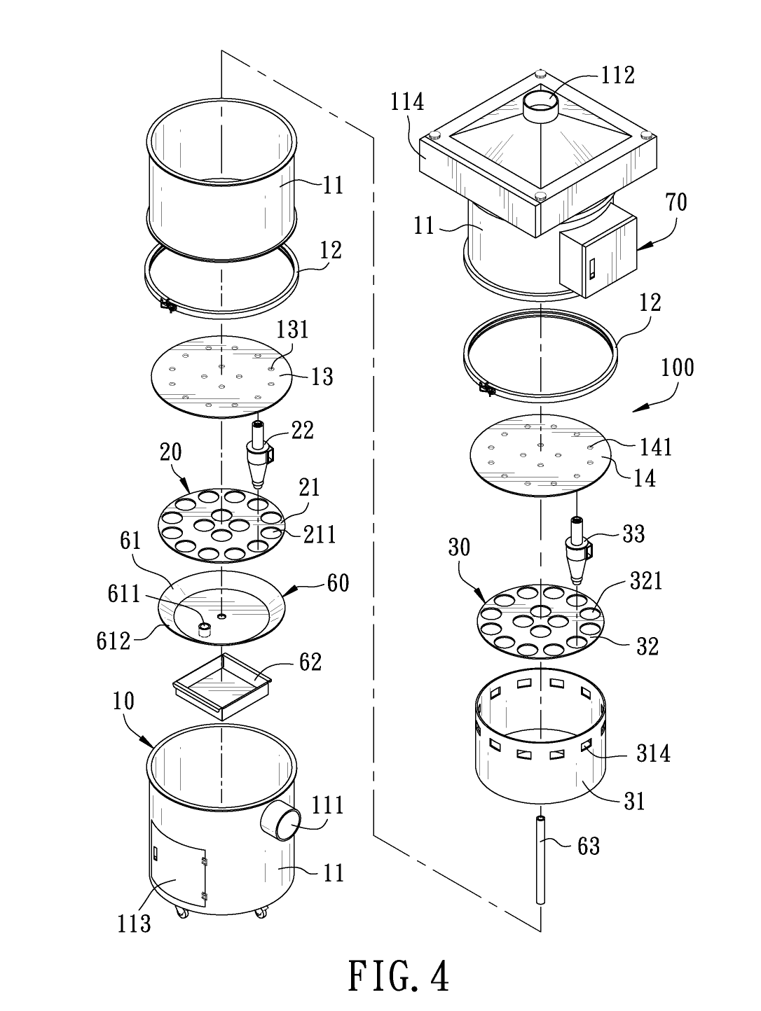

FIG. 5 is a perspective view of a first filtration device in the preferred embodiment of an oil mist separator in the present invention;

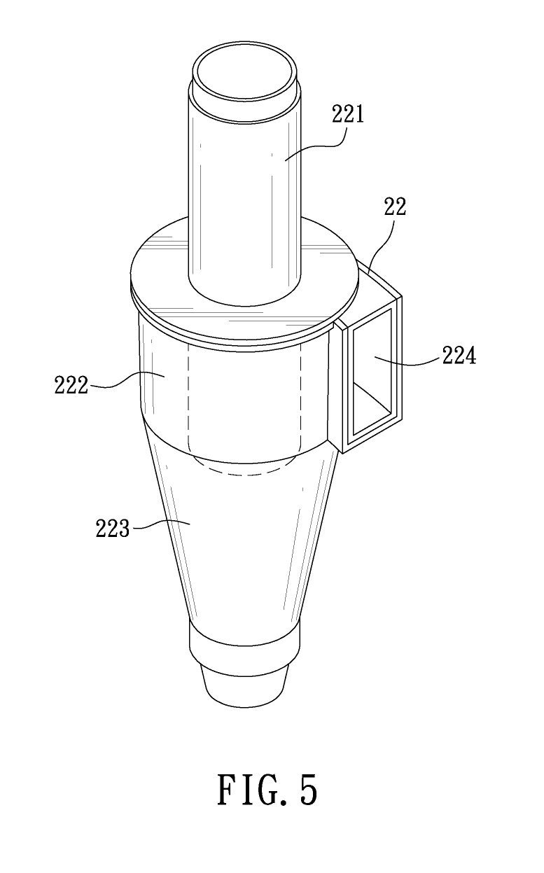

FIG. 6 is a cross-sectional view of the preferred embodiment of an oil mist separator in the present invention, showing how it works; and

FIG. 7 is a cross-sectional view of the first filter in the preferred embodiment of an oil mist separator in the present invention, showing how the first filter works.

### DETAILED DESCRIPTION OF THE PREFERRED EMBODIMENT

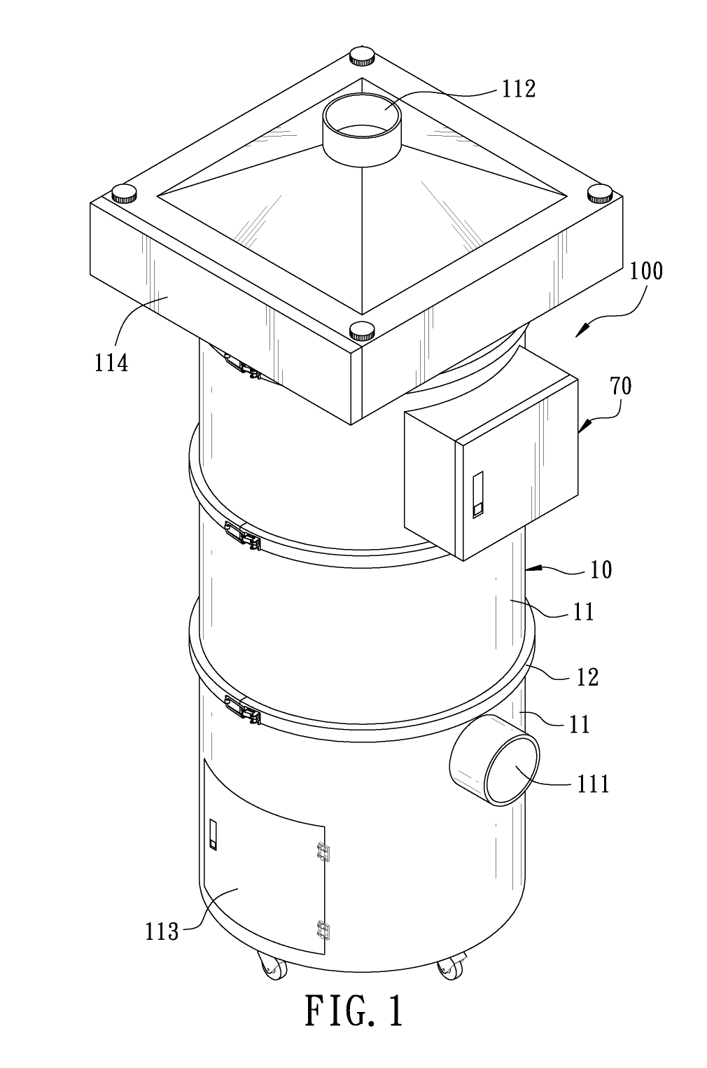

As shown in FIGS. 1˜5, a preferred embodiment of an oil mist separator 100 in the present invention consists of a shell 10, a first filter unit 20, a second filter unit 30, an inlet unit 40, a third filter unit 50, an oil collecting unit 60 and an electric control box 70.

The shell 10 is composed of plural layers 11, and a constricting ring 12 wrapped around the conjunction of every two adjacent layers 11 to fix them tightly. Consecutively positioned upward in the shell 10 are a first separating plate 13, a second separating plate 14 and a third separating plate 15, which define a first chamber 16, a second chamber 17, a third chamber 18 and a fourth chamber 19 correspondingly. The first separating plate 13 is provided with plural first through holes 131. The second separating plate 14 is provided with plural second through holes 141. The third separating plate 15 is provided with at least a third through hole 151. Moreover, the shell 10 is also provided with an air inlet 111 bored in one side to communicate with the first chamber 16, an air exit 112 bored in the top to communicate with the fourth chamber 19, a first gate 113 bored in the wall of the first chamber 16, and a second gate 114 bored in the wall of the fourth chamber 19.

The first filter unit 20 is installed in the first chamber 16, provided with a first fixing plate 21 parallel to the first separating plate 13, and plural first filters 22 installed between the first separating plate 13 and the first fixing plate 21. The first fixing plate 21 is bored with plural first fixing holes 211 corresponding to the first through holes 131 of the first separating plate 13. Each of the first filters 22 is provided with an inner tube 221 having an upper end connected with the first through hole 131 and a lower end kept free. An outer tube 222 surrounds part of the inner tube 221, with an upper end flatly sealed with the inner tube 221 and a lower end gradually tapered downward to form a conical portion 223 fitting in the first fixing hole 211 of the first fixing plate 21. In addition, an opening 224 is formed at one side of the outer tube 222, located between the first separating plate 13 and the first fixing plate 21.

The second filter unit 30 is installed in the second chamber 17, provided with a fixing tank 31 having a circumferential wall 311 connected with the second separating plate 14 and a bottom wall 312 formed at the bottom, with an outmost circumferential portion of the bottom wall 312 curved up to form an annular sloping surface 313 connected to the circumferential wall 311. A plurality of through holes 314 are bored around the upper portion of the circumferential wall 311, enabling the fixing tank 31 to communicate with the second chamber 17. And the outer surfaces of the circumferential wall 311 and those of the bottom wall 312 are kept apart from the inner wall of the shell 10 with a preset distance, so that a passage “a” is formed between them. Deposited in the fixing tank 31 is a second fixing plate 32 parallel to the second separation plate 14. The second fixing plate is bored with plural second fixing holes 321 corresponding to the second through holes 141 of the second separating plate 14. And plural second filters 33 are installed between the second separating plate 14 and the second fixing plate 32. Each of the second filters 33 is provided with an inner tube 331 having an upper end connected with the second through hole 141 and a lower end kept free. An outer tube 332 surrounds part of the inner tube 331, with an upper end flatly sealed with the inner tube 331 and a lower end gradually tapered downward to form a conical portion 333 fitting in the second fixing hole 321. In addition, an opening 334 is formed at one side of the outer tube 332, located between the second separating plate 14 and the second fixing plate 32.

The inlet unit 40 is installed in the third chamber 18, provided with a fixing plate 41 parallel to the third separating plate 15, with plural through holes 411 bored around the fixing plate 41. In addition, the inlet unit 40 is also provided with a blower 42 and a flow-guiding member 43. The blower 42 includes a motor 421 installed between the third separation plate 15 and the fixing plate 41 and having an output shaft 422 inserted through the fixing plate 41 to connect with a blade 423. The flow-guiding member 43 is located between the fixing plate 41 and the second separating plate 14, provided with a bottom plate 431 having the outmost circumferential portion curved up to form an annular sloping plate 432. Corresponding to the blade 423, a conical hole 433 is tapered upward from the bottom plate 431, with an annular plate 434 flatly extended outward from the top edge of the conical hole 433.

The third filter unit 50 is installed in the fourth chamber 19, provided with at least a layer of filter 51 that can be a regular filter, a HEPA (high efficiency particulate air filter) or an active carbon filter. In this embodiment, three layers of the filter 51 are employed in the third filter unit 50.

The oil collecting unit 60 is installed in the first chamber 16, provided with an oil collecting plate 61 located under the first fixing plate 21, with the outmost circumferential portion of the oil collecting plate 61 curved up to form an annular sloping surface 612 and at least an oil exit 611 bored in the oil collecting plate 61. Moreover, the oil collecting unit 60 is additionally provided with an oil tray 62 positioned under the oil exit 611, and an oil exhaust tube 63 having two ends respectively connected with the bottom wall 312 of the fixing tank 31 and the oil collecting plate 61.

The electric control box 70 is installed at one side of the shell 10, utilized to accommodate necessary control devices to operate the oil mist separator 100.

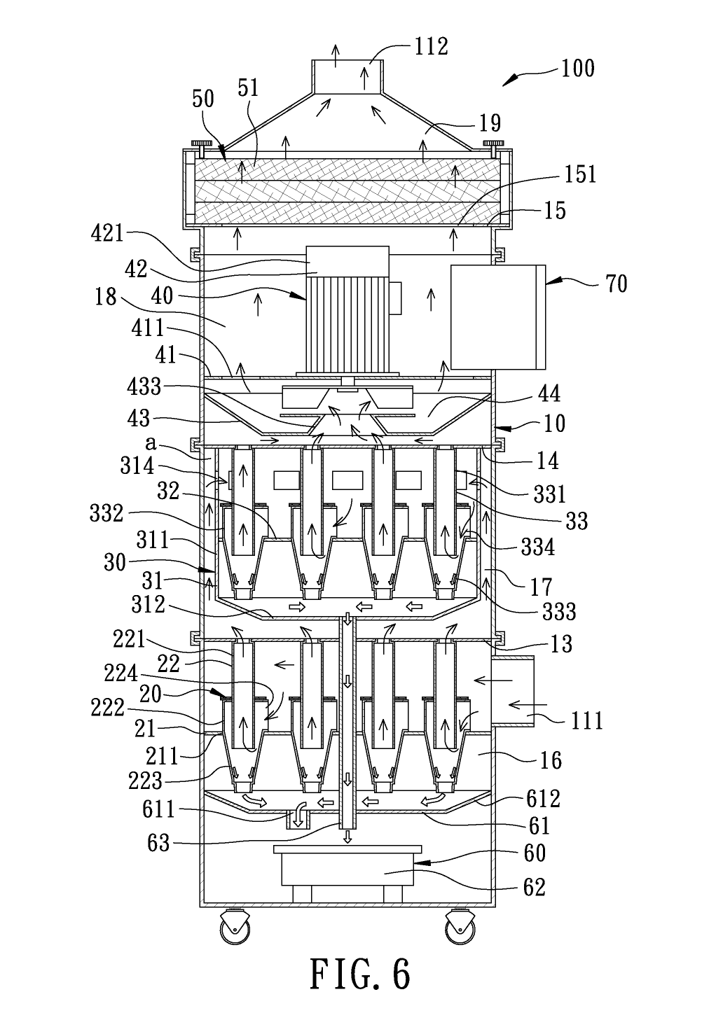

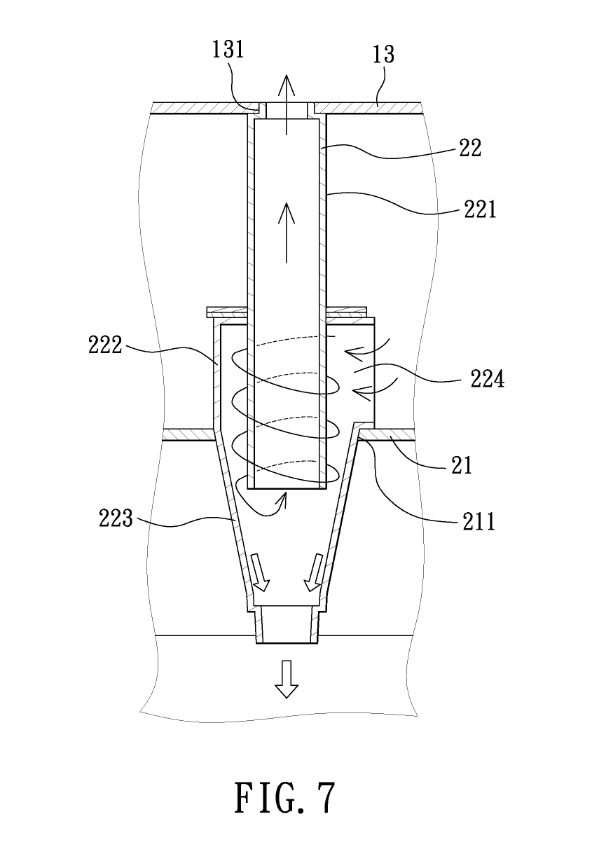

In operation, as shown in FIGS. 6 and 7, when the oil mist separator 100 is installed in a kitchen or a factory full of oil mist, the inlet unit 40 is to be started to suck oil mist through the air inlet 111 into the first chamber 16. The oil mist is further to flow through the openings 224 of the first filters 22. By the time, by means of the conical portion 223, the oil mist is spirally flowing down along the inner wall of the outer tubes 222, with oil and water mixed in the air flung out by a centrifugal force. The oil and water are to drop to the oil collecting plate 61 and further flow through the oil exit 611 into the oil tray 62. In this first stage of separation, most of the oil and water are to be removed.

Next, the oil mist is to flow through the inner tubes 221 into the second chamber 17, the passage “a”, the through holes 314, the fixing tank 31, the openings 334 and the second filters 33 successively. By the time, by means of the conical portion 333, the oil mist is to spirally flow down along the inner wall of the outer tubes 332, with oil and water flung out by a centrifugal force. Then, the oil and water are to flow through the oil exhaust tube 63 to drop into the oil tray 62. Thus the oil and water still remaining in the mist can further be removed. Thus a second stage of separation is finished.

Finally, the oil mist is to flow through the inner tubes 331 into the third chamber 18. By the time, with the flow-guiding member 43, the oil mist is to pass through the through holes 411 of the fixing plate 41 circuitously. Then it is to flow through the third through holes 151 of the third separating plate 15 into the fourth chamber 19. By means of the third filter unit 50 equipped with the filters 51 with diverse functions, the slight oil, water, odor and powders possibly still existing in the mist can be effectively removed. Thus a third last stage of separation is finished. So the oil mist separator 100 can not only make the air contaminated by oil totally recovered with a multi-layer filtration, but also reduce consumption of filters to lower cost and be friendly to environment.

It should be noted that, with the annular sloping surface 313 of the fixing tank 31 and the annular sloping surface 612 of the oil collecting plate 61, oil and water can easily flow into the oil tray 62, and with the annular sloping plate 432 of the flow-guiding member 43, the oil mist can be smoothly led to pass through the through holes 411 of the fixing plate 41. Moreover, as the motor 421 of the blower 42 is installed in the third chamber 18, heat generated by the motor 421 can be removed together with the oil mist so as to prolong service life of the motor 421.

Furthermore, for users, it is convenient to clean up the oil tray 62 through the first gate 113 and replace the filters 51 of the third filter unit 50 with new ones through the second gate 114, if necessary . . . .

While the preferred embodiment of the invention has been described above, it will be recognized and understood that various modifications may be made therein and the appended claims are intended to cover all such modifications that may fall within the spirit and scope of the invention.

What is claimed is:

1. An oil mist separator comprising:
a shell having an interior installed upward with a first separating plate and a second separating plate and a third separating plate that correspondingly define a first chamber and a second chamber and a third chamber and a fourth chamber, said first separating plate provided with plural first through holes, said second separating plate provided with plural second through holes, said third separating plate provided with at least a third through hole, an air inlet bored in one side of said shell to communicate with said first chamber, an air exit bored in a top of said shell to communicate with said fourth chamber;
a first filter unit installed in said first chamber and provided with a first fixing plate parallel to said first separating plate, said first fixing plate bored with plural first fixing holes corresponding to said first through holes of said first separating plate, plural first filters installed between said first separating plate and said first fixing plate, each of said first filters provided with an inner tube having an upper end connected with said first through hole of said first separating plate and a lower end kept free, an outer tube surrounding part of said inner tube with an upper end flatly sealed with said inner tube and a lower end gradually tapered downward to form a conical portion connected with said first fixing hole, an opening formed at one side of said outer tube and located between said first separation plate and said first fixing plate;
a second filter unit installed in said second chamber and provided with a fixing tank having a circumferential wall connected with said separating second plate and a bottom wall formed at a bottom, outer surfaces of said circumferential wall together with those of said bottom wall spaced apart from an interior wall of said shell with a certain distance to form a passage, a plurality of through holes bored around said circumferential wall, a second fixing plate deposited in said fixing tank in parallel to said second separating plate, said second fixing plate bored with plural second fixing holes corresponding to said second through holes of said second separating plate, plural second filters installed between said second separating plate and said second fixing plate, each of said second filters provided with an inner tube having an upper end connected with said second through hole and a lower end kept free, an outer tube surrounding part of said inner tube and having an upper end flatly sealed with said inner tube and a lower end gradually tapered downward to form a conical portion connected with said second fixing hole, an opening formed at one side of said outer tube and located between said second separating plate and said second fixing plate;
an inlet unit installed in said third chamber and provided with a fixing plate parallel to said third separation plate with plural through holes, a blower installed on said fixing plate and provided with a motor positioned between said third separating plate and said fixing plate, said motor having an output shaft inserted through said fixing plate to connect with a blade; and
a third filter unit installed in said fourth chamber and provided with at least a layer of filter

2. The oil mist separator as claimed in claim 1, wherein said shell is composed of plural layers.

3. The oil mist separator as claimed in claim 1, wherein said bottom wall of said fixing tank has an outmost circumferential portion connected to said circumferential wall and curved up to form an annular sloping surface.

4. The oil mist separator as claimed in claim 1, wherein a flow-guiding plate is installed between said fixing plate of said inlet unit and said second separating plate and provided with a bottom plate having a conical hole formed in a center to correspond to said blade.

5. The oil mist separator as claimed in claim 4, wherein an outmost circumferential portion of said bottom plate is curved up to form an annular sloping surface.

6. The oil mist separator as claimed in claim 4, wherein said conical hole of said flow-guiding plate has a top edge flatly extended outward to form an annular plate.

7. The oil mist separator as claimed in claim 1, wherein said oil mist separator is further provided with an oil collecting unit installed in said first chamber and having an oil collecting plate located under said first fixing plate, at least an oil exit bored in said oil collecting plate, an oil tray positioned under said oil exit, an oil exhaust tube having two ends respectively connected with said bottom wall of said fixing tank and said oil collecting plate.

8. The oil mist separator as claimed in claim 7, wherein an outmost circumferential portion of said bottom plate is curved up to form an annular sloping surface.
